(19) United States
(12) Patent Application Publication
(10) Pub. No.: US 2015/0322670 A1
(43) Pub. Date: Nov. 12, 2015

(54) Soundproofing Panel

(71) Applicant: SAINT-GOBAIN PLACO SAS, Suresnes (FR)

(72) Inventors: Glen Hotchin, Coventry (GB); Nicholas Jones, Melton Mowbray (GB)

(73) Assignee: SAINT-GOBAIN PLACO SAS, Suresnes (FR)

(21) Appl. No.: 14/651,861

(22) PCT Filed: Dec. 12, 2013
(86) PCT No.: PCT/EP2013/076317

§ 371 Date: Jun. 12, 2015

(30) Foreign Application Priority Data
Dec. 12, 2012 (EP) 12290435.2
Jun. 11, 2013 (EP) 13290133.1

(51) Int. Cl. E04B 1/84; E04B 2/00; B32B 27/30; B32B 13/12; B32B 27/32; E04C 2/26; E04C 2/52

(52) U.S. Cl. CPC E04B 1/8409; E04C 2/26; E04C 2/46; E04C 2/52; B32B 13/12; B32B 27/32; B32B 27/304; E04B 2001/8461; E04B 2103/04; B32B 2260/046; B32B 2262/101; B32B 2307/102; B32B 2607/00

(57) ABSTRACT

A panel for use in building construction comprises a plasterboard having two opposed faces, a polymer-based lamina being provided on one of these faces. The weight per unit area of the panel lies in the range 13.5 to 17.5 kg/m², and the thickness of the panel lies in the range 11-25 mm.

The present invention relates to a laminated building panel with improved acoustical soundproofing properties

It is well-known to form acoustic building panels for walls, ceilings, floors and the like by laminating together two or more substrate layers. One such building panel is disclosed in WO2008/124672 and comprises a pair of plasterboard substrate layers are bonded together with an acrylic glue.

Surprisingly, it has been found that it is not necessary for soundproofing panels to be formed from boards of the same thickness. In fact, acoustic performance may also be improved by providing a thinner backing lamina on the back of a substrate board.

Furthermore, by selecting a polymer-based backing lamina, the backing lamina may also serve the purpose of reinforcing the substrate board, such that fixtures (such as sinks, televisions, radiators, fire extinguishers, shelves and any other item that requires attachment to the panel) may be attached more securely to the panel.

In addition, the use of a polymer-based backing lamina tends to reduce the overall weight of the soundproofing panel, thus enabling the panel to be handled with greater ease and safety. This may make it easier to comply with regulations relating to manual handling.

Therefore, in a first aspect, the present invention may provide a panel comprising a plasterboard having a front face and a back face, the panel being for use in mounting on a support structure to provide a partition, such that the back face of the board faces towards the support structure;
wherein a polymer-based lamina is provided on the back face of the plasterboard
and further wherein the weight per unit area of the panel lies in the range 13.5 to 17.5 kg/m², and the thickness of the panel lies in the range 11-25 mm.

If the weight per unit area is greater than the stated range, then manual handling properties of the panel may be adversely affected. If the weight per unit area is less than the stated range, then there may be little advantage to the provision of an additional layer on the back face of the plasterboard: that is, it has been found that the soundproofing properties of the panel are not significantly better than those of a plasterboard having an equivalent thickness.

Typically, the faces of the plasterboard each have an area in the range 2-4 m², preferably in the range 2.5-3.5 m².

The lamina represents a layer that provides a discrete component of the panel, that is, it is not integrally formed with the plasterboard. Effectively, there is a well-defined interface or boundary between the plasterboard and the lamina.

Preferably, the polymer-based lamina comprises principally a thermoplastic polymer. Alternatively, the polymer-based lamina may comprise principally a thermosetting polymer.

The polymer-based lamina may be provided by a monolithic polymer, that is, a unitary, non-composite material. Alternatively, the polymer-based lamina may be provided by a composite material, for example, a fibre-reinforced polymer, such as fibreglass. Preferably, the fibreglass has a polyester or polypropylene matrix. In certain cases, the fibreglass has an epoxy matrix.

Typically, the plasterboard comprises gypsum plaster extruded between two paper or glass fibre sheets. The gypsum plaster may comprise various additives as generally known in the art.

Typically, the polymer-based lamina is glued to the plasterboard. In general, the layer of glue is very thin, such that the gap between the polymer-based lamina and the plasterboard is less than 0.3 mm, preferably less than 0.2 mm, more preferably less than 0.1 mm.

In certain embodiments, a further lamina may be provided on the outer surface of polymer-based lamina (that is, distal to the plasterboard). The further lamina may be, for example, an insulating layer, a paper layer, or a metal (e.g. copper) layer.

In other embodiments, a thin film may be provided directly on the surface of the plasterboard, on the inner face of the polymer-based lamina, or on the outer face of the polymer-based lamina.

In still further embodiments, a paper layer may be provided over the outer surface of the polymer-based lamina.

Typically, the polymer-based lamina has a thickness of at least 0.25 mm, preferably at least 0.5 mm, more preferably at least 1 mm. Such thickness may provide the necessary stiffness to the lamina, such that it can improve the fixing strength of the panel.

Typically, the thickness of the lamina is less than 5 mm, preferably less than 4 mm, more preferably less than 2.5 mm. Preferably, the thickness of the polymer-based lamina is less than 25% of the thickness of the plasterboard, more preferably less than 20%.

A typical panel may comprise a gypsum plasterboard of 10-20 mm thickness.

Typically, the lamina is solid and non-porous. This may assist in providing the lamina with the necessary stiffness to improve the fixing strength of the panel. The phrase “solid and non-porous” is intended to exclude laminae that comprise a 3-dimensional porous array. The phrase is not intended to exclude laminae that have apertures, cut-outs, or perforations extending through the thickness of the lamina. For example, it is envisaged that the lamina may include a 2-dimensional distribution of through-thickness apertures.

In general, the polymer-based lamina is selected from the group comprising: polyvinylchloride, HDPE, polypropylene, and fibre composite materials such as fibreglass. In the case that the polymer-based lamina is a fibre composite material other than fibreglass, it may comprise e.g. cellulose fibres.

Typically, the density of the polymer-based lamina is in the range 700-1500 kg/m³.

In general, the modulus of elasticity of the polymer-based lamina is at least 500 MPa, preferably at least 750 MPa, more preferably at least 900 MPa.

Typically, the sound reduction index of a partition wall formed from two of the panels, when measured at a frequency between 1600 and 5000 Hz, is at least 5 dB greater than that of a partition wall formed from two notional panels having an equivalent mass per unit area to the panel of the invention, the notional panels each comprising solely a plasterboard.

In a second aspect, the present invention may provide a partition comprising at least one panel according to any the first aspect of the invention, the panel being mounted onto a support structure, wherein the back face of the plasterboard faces the support structure.

Effectively, therefore, the panel is oriented such that fixtures may be mounted on the front face of the board, while the polymer-based lamina on the back face of the board may serve to provide improved retention of the fixtures to the board, as well as enhanced acoustic performance.

The partition may be upright, for example to provide a wall, or it may be arranged on a level, for example to provide a ceiling.

The second aspect of the invention may include one or more of the optional features of the first aspect of the invention.

In a third aspect, the present invention may provide a panel for use in building construction, the panel comprising a gypsum board having two opposed faces, a polymer-based lamina being provided on one of the faces of the gypsum board,
wherein the sound reduction index of a partition wall formed from two of the panels, when measured at a frequency between 1600 and 5000 Hz, is at least 5 dB greater than that of a partition wall formed from two notional panels having an equivalent mass per unit area to the panel of the invention, the notional panels each comprising solely the material of the substrate board.

The third aspect of the invention may include one or more of the optional features of the first aspect of the invention.

The invention will now be described by way of example with reference to the following Figures in which:

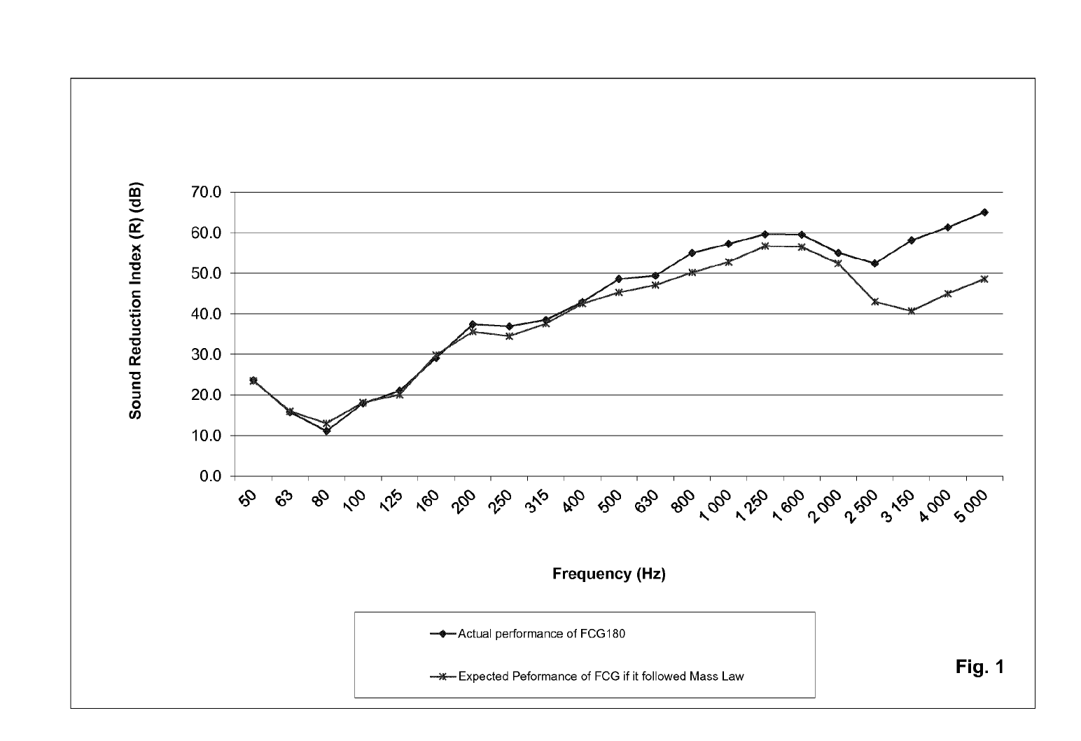

FIG. 1 is a graph of sound attenuation vs. frequency for a) measured results for Example 1; and b) calculated results for Example 1

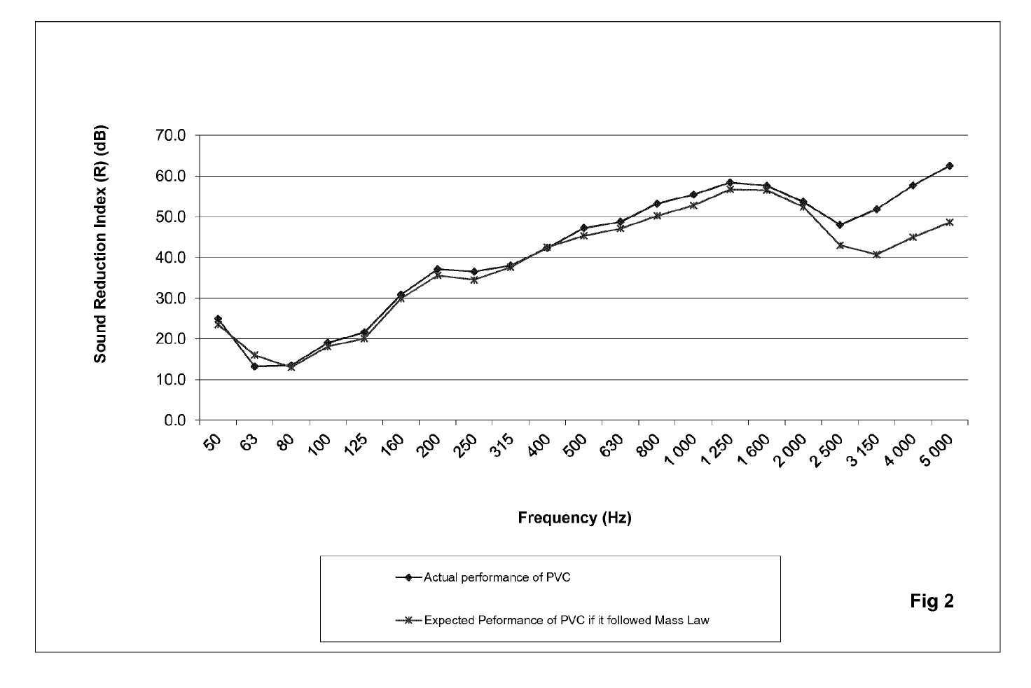

FIG. 2 is a graph of sound attenuation vs. frequency for a) measured results for Example 2; and b) calculated results for Example 2

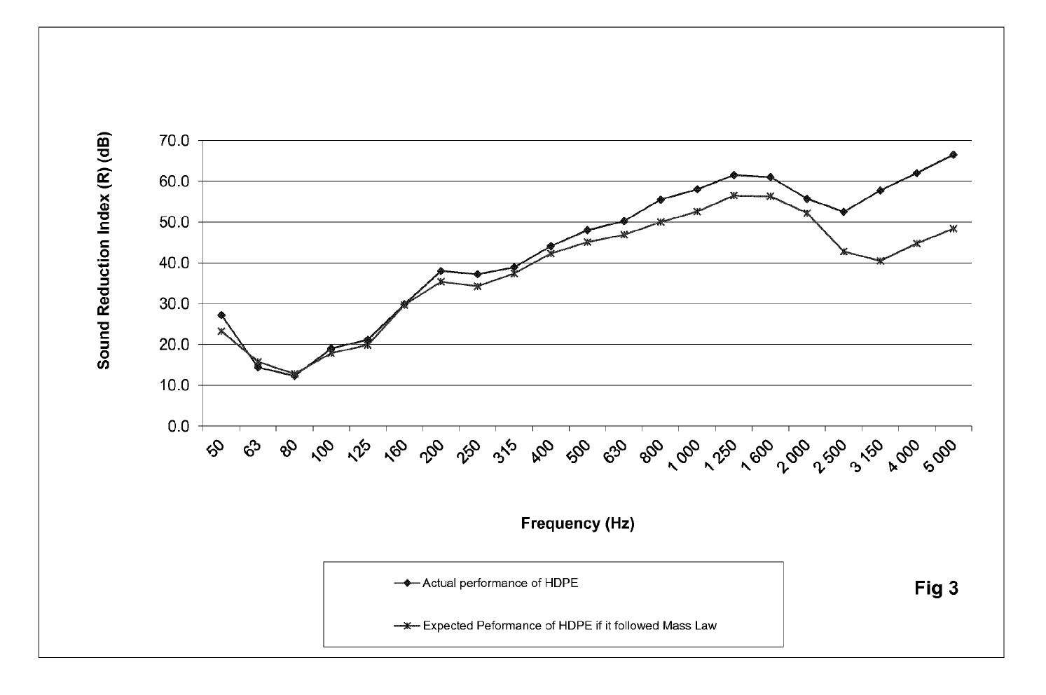

FIG. 3 is a graph of sound attenuation vs. frequency for a) measured results for Example 3; and b) calculated results for Example 3

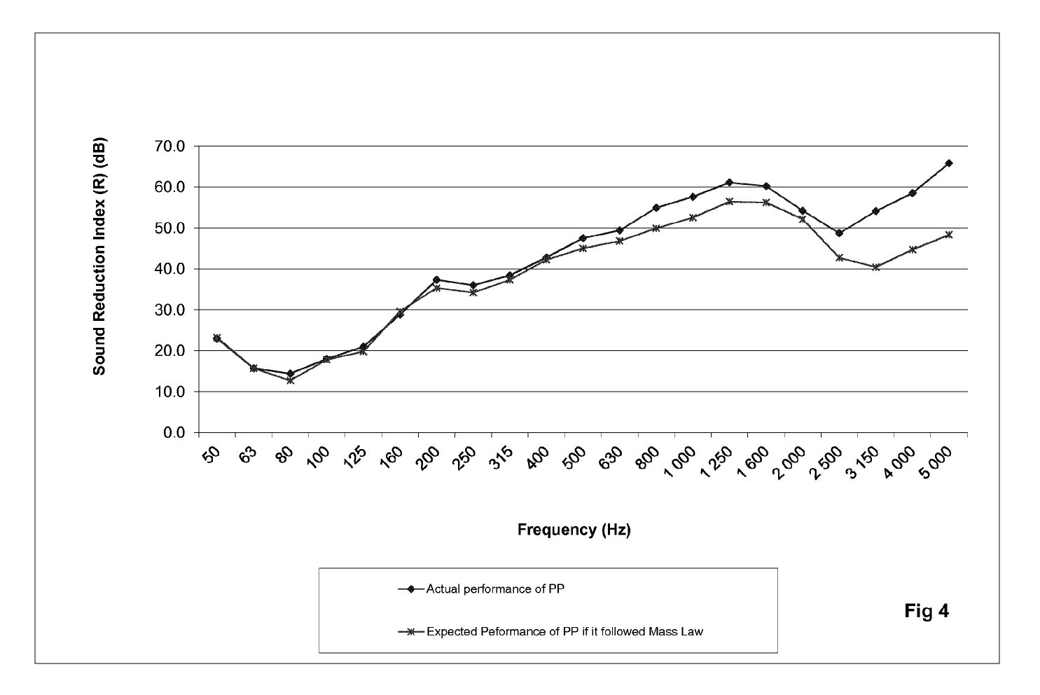

FIG. 4 is a graph of sound attenuation vs. frequency for a) measured results for Example 4; and b) calculated results for Example 4

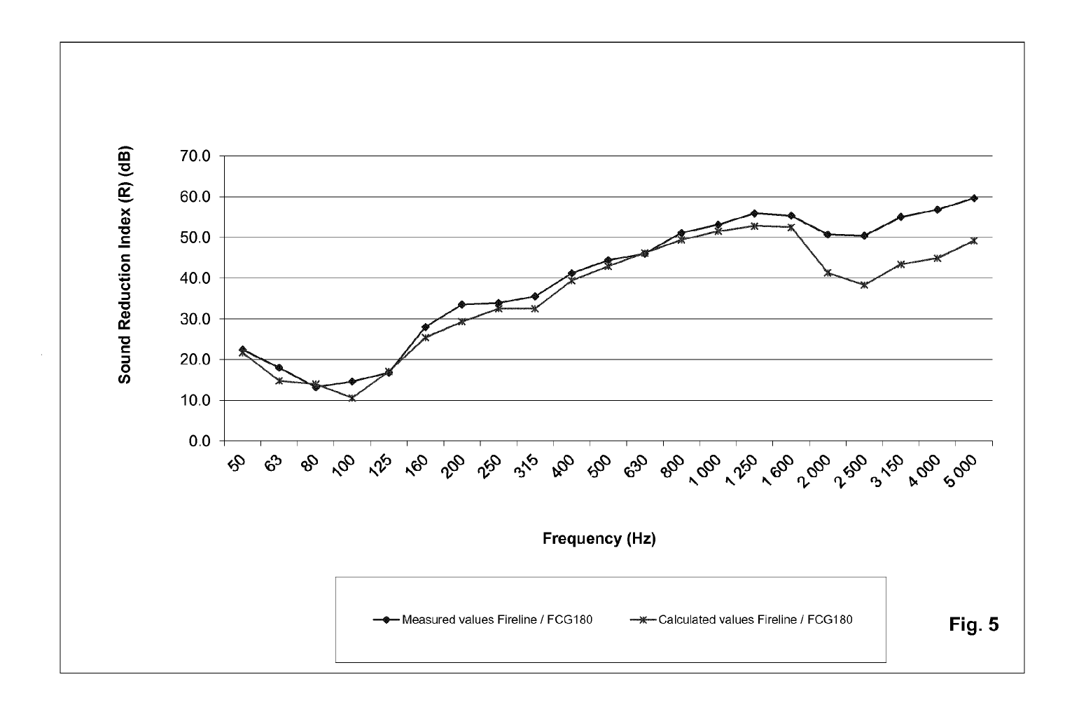

FIG. 5 is a graph of sound attenuation vs. frequency for a) measured results for Example 5; and b) calculated results for Example 5

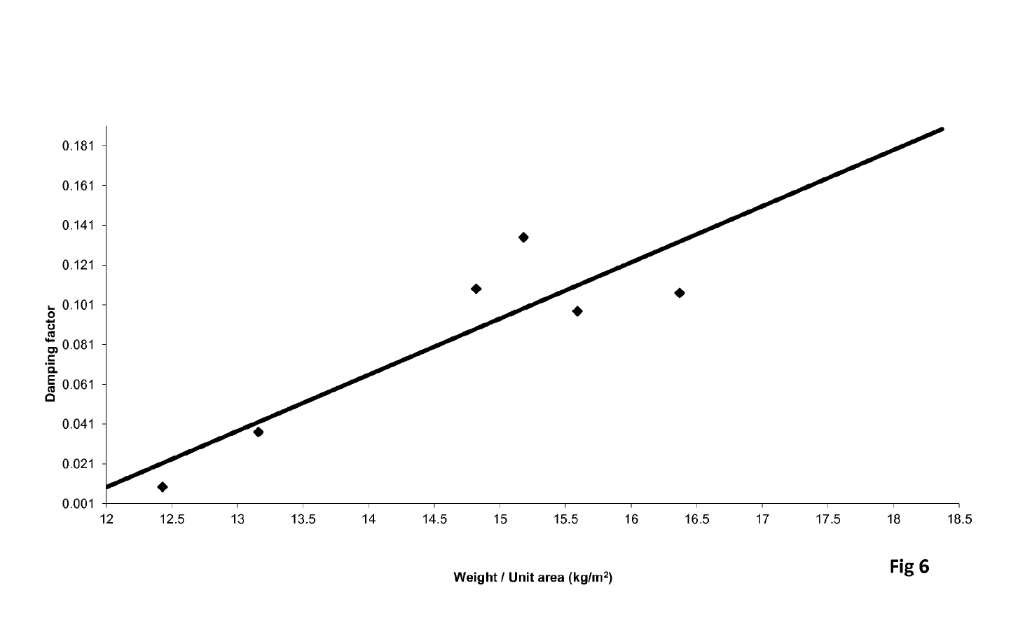

FIG. 6 is a graph of damping factor against weight per unit area for Examples 6-9 and Comparative Examples 1-2.

### EXAMPLES

Panels were prepared by gluing a lamina to a gypsum plasterboard using Bostik Aquagrip™ 29860 glue. Details of the plasterboard and lamina are set out in Table 1:

TABLE 1

| Example | Plasterboard | Lamina |
|---|---|---|
| Example 1 | 15 mm thick Duraline ™ | 1.8 mm thick FCG180 |
| | | fibreglass sheet from Crane |
| | | Composites |
| Example 2 | 15 mm thick Duraline ™ | 2 mm thick PVC sheet |
| Example 3 | 15 mm thick Duraline ™ | 2 mm thick HDPE sheet |
| Example 4 | 15 mm thick Duraline ™ | 2 mm thick polypropylene |
| | | sheet |
| Example 5 | 12.9 mm thick Fireline ™ | 1.8 mm thick FCG180 |
| | | fibreglass sheet from Crane |
| | | Composites |

| | |
|---|---|
| Example 6 | Gypsum board + epoxy composite lamina: |
| | total thickness = 15 mm |
| Example 7 | Gypsum board + polypropylene/non-woven glass |
| | composite lamina: total thickness = 15mm |
| Example 8 | Gypsum board + polyester/non-woven glass composite |
| | lamina: total thickness = 15mm |
| Example 9 | Gypsum board + vinyl acetate lamina: total thickness = |
| | 15 mm |
| Comparative | Gypsum board + LDPE foam lamina: total thickness = |
| Example 1 | 16mm |
| Comparative | Gypsum board |
| Example 2 | |

### Acoustic Testing

Acoustic testing was carried out according to BS EN IS0140-3:1995.

A test specimen was constructed in an aperture having an overall opening 2400 mm high by 3600 mm wide, to provide a partition wall between a source room and a receiving room.

The test specimen was prepared by constructing a framework comprising floor and ceiling channels fixed to the base and head of the test aperture respectively, and studs extending between the floor and ceiling channels at each end of the aperture and at intervals therebetween. The framework was clad on each side with a single layer of the panel being tested, the panel being oriented such that the lamina faced into the interior of the test specimen.

A loudspeaker was positioned in the source room, and a rotating microphone boom in the receiving room measured the average sound pressure level transmitted through the test specimen.

Test curves were obtained for sound absorption for frequencies from 50 Hz to 5000 Hz.

### Calculations

From sound attenuation tests carried out on unclad Duraline and Fireline boards, theoretical sound attenuation curves were calculated for each of Examples 1-5. These were based on the sound attenuation that would be expected from a board whose mass is increased by an amount corresponding to the mass of the respective lamina. The following formula was used to calculate the expected sound attenuation:

Expected SA_{B+L}=Measured SA_{B}+25*log₁₀[(m_{B}+m_{L})/(m_{B})]

wherein:

Expected SA_{B+L}=expected sound attenuation for board+lamina [dB]

Measured SA_{B}=measured sound attenuation for board alone [dB]

m_{B}=mass of board

m_{L}=mass of lamina

The coefficient of 25 has been derived empirically for single layer, double leaf constructions.

FIGS. 1-5 show curves for measured and calculated sound attenuation for Examples 1-5. The actual measurements are typically greater than the calculated values at equivalent frequency, particularly at frequencies greater than about 2000 Hz.

### Damping Factor

The damping factor of the panels was measured using an Impulse Excitation technique. The panel was supported at two nodal points and caused to vibrate by an automated tapping device. The vibration signal emitted by the sample was captured using a microphone, and the damping factor calculated using the following equation:

$${Q}^{- 1} = \frac{1}{π} ( \frac{{x}_{n}}{{x}_{n + 1}} )$$

wherein Q⁻¹=damping factor
xₙ=signal amplitude at cycle number n
xₙ₊₁=signal amplitude at cycle number n+1

The damping factor was measured at the resonant frequency for the respective panel.

The results are set out in Table 2 and illustrated in FIG. 6.

TABLE 2

| | Mass per | Resonant | |
|---|---|---|---|
| | unit area | frequency | Damping |
| Sample | (kg/m²) | (Hz) | factor |
| Example 6 | 15.59 | 944 | 0.098 |
| Example 7 | 14.82 | 1250 | 0.11 |
| Example 8 | 15.18 | 260 | 0.14 |
| Example 9 | 16.37 | 167.5 | 0.11 |
| Comparative | 13.16 | 743 | 0.037 |
| Example 1 | | | |
| Comparative | 12.43 | 840 | 0.0094 |
| Example 2 | | | |

1. A panel comprising a plasterboard having a front face and a back face, the panel being for use in mounting on a support structure to provide a partition, such that the back face of the board faces towards the support structure;
wherein a polymer-based lamina is provided on the back face of the plasterboard,
and further wherein the weight per unit area of the panel lies in the range 13.5 to 17.5 kg/m², and the thickness of the panel lies in the range 11-25 mm.

2. A panel according to claim 1, wherein the polymer-based lamina is either a monolithic polymer or a composite having a polymer matrix.

3. A panel according to claim 2, wherein the polymer-based lamina is provided by a fibre-reinforced polymer.

4. A panel according to claim 1, wherein the polymer-based lamina is provided by thermoplastic polymer.

5. A panel according to claim 1, wherein the polymer-based lamina is glued to the plasterboard.

6. A panel according to claim 1, wherein the thickness of the polymer-based lamina is less than 20% of the thickness of the plasterboard.

7. A panel according to claim 1, wherein the thickness of the polymer-based lamina is less than 5 mm.

8. A panel according to claim 1, wherein the polymer-based lamina is selected from the group comprising: polyvinylchloride, HDPE, and polypropylene.

9. A panel according to claim 1, wherein the polymer-based lamina comprises a glass-reinforced polymer.

10. A panel according to claim 1, wherein the density of the polymer-based lamina is in the range 700-1500 kg/m³.

11. A panel according to claim 1, wherein the Modulus of Elasticity of the polymer-based lamina at least 500 MPa.

12. A panel according to claim 1, wherein the sound reduction index of a partition wall formed from two of the panels, when measured at a frequency between 1600 and 5000 Hz, is at least 5 dB greater than that of a partition wall formed from two notional panels having an equivalent mass per unit area to the claimed panel, the notional panels each comprising solely a plasterboard.

13. A partition comprising at least one panel according to claim 1, the panel mounted onto a support structure, wherein the back face of the plasterboard faces the support structure.

14. A panel for use in building construction, the panel comprising a gypsum board having two opposed faces, a polymer-based lamina being provided on one of the faces of the gypsum board,
wherein the sound reduction index of a partition wall formed from two of the panels, when measured at a frequency between 1600 and 5000 Hz, is at least 5 dB greater than that of a partition wall formed from two notional panels having an equivalent mass per unit area to the claimed panel, the notional panels each comprising solely the material of the substrate board.
